(19) United States
(12) Patent Application Publication
(10) Pub. No.: US 2012/0002323 A1
(43) Pub. Date: Jan. 5, 2012

(54) METHOD FOR INSPECTION OF MAGNETIC RECORDING MEDIUM, MAGNETIC RECORDING MEDIUM, AND MAGNETIC RECORDING/REPRODUCING DEVICE

(75) Inventors: Junya Kato, Chiba-shi (JP); Yoshihiko Maruyama, Ichihara-shi (JP)

(73) Assignee: Showa Denko K.K., Minato-ku, Tokyo (JP)

(21) Appl. No.: 13/256,575

(22) PCT Filed: Mar. 16, 2010
(86) PCT No.: PCT/JP2010/001857

§ 371 Date: Sep. 14, 2011

(30) Foreign Application Priority Data
Mar. 18, 2009 (JP) 2009-066736

(51) Int. Cl. G11B 15/18; G11B 5/66; G01N 27/72

(52) U.S. Cl. 360/99.08; 436/127; 428/831; G9B/15.021

(57) ABSTRACT

Disclosed is a method for inspecting a magnetic recording medium in which the adhesion (transfer) of contaminants or corrosive materials to a magnetic head can be prevented. Specifically disclosed is a method for inspecting a magnetic recording medium including a non-magnetic substrate and additionally comprising at least a magnetic layer, a protective layer and a lubricant layer all provided on the non-magnetic substrate. The method is characterized by including exposing the magnetic recording medium to an atmosphere containing a siloxane and determining the resistance of the magnetic recording medium against environmental substances based on the amount of the siloxane attached to the surface of the magnetic recording medium.

### TECHNICAL FIELD

The present invention relates to a method for inspection of a magnetic recording medium, a magnetic recording medium, and a magnetic recording/reproducing device.

Priority is claimed on Japanese Patent Application No. 2009-66736, filed on Mar. 18, 2009, the content of which is incorporated herein by reference.

### BACKGROUND ART

Recently, a recording density of a magnetic recording/reproducing device is 400 Gbits per square inch has been realized, and the recording density of the magnetic recording/reproducing device is expected to continuously increase. To increase the recording density of the magnetic recording/reproducing device, a magnetic recording medium suitable for high recording density has been developed. As a magnetic recording medium, a configuration is mainly employed such that a recording layer and the like are layered on a substrate used for the magnetic recording medium by a sputtering method or the like, a protective film of carbon or the like is formed on the recording layer, and then a liquid lubricant is coated on the protective film.

In this configuration, the protective layer functions to protect information recorded in the recording layer, to enhance a sliding characteristic of the magnetic head, and to cover the recording layer to prevent metal included in the recording layer from being corroded by environmental contaminants. However, the protection of the magnetic recording medium is insufficient with only the protective layer. Thus, a lubricant having a thickness of about 0.5 to about 3 nm is coated on the surface of the protective layer to form a lubricant layer, thereby enhancing the durability or protective force of the protective layer. In this way, by forming the lubricant layer, it is possible to prevent the magnetic head (magnetic head slider) from being in direct contact with the protective layer, to noticeably reduce the frictional force of the magnetic head (magnetic head slider) sliding on the magnetic recording medium, and to prevent contaminants from entering inside the magnetic recording medium.

Here, as the lubricant, there has been proposed in the related art a perfluoropolyether based lubricant, an aliphatic hydrocarbon based lubricant, or the like. For example, Patent Document 1 discloses a magnetic recording medium which is coated with a lubricant of perfluoroalkylpolyether having a structure of HOCH₂—CF₂O—(C₂F₄O)p-(CF₂O)q-CH₂OH (p and q are integers). Further, Patent Document 2 discloses a magnetic recording medium which is coated with a lubricant of perfluoroalkylpolyether (TETRAOL) having a structure of HOCH₂CH(OH)—CH₂OCH₂CF₂O—(C₂F₄O)p-(CF₂O)q-CF₂CH₂OCH₂—CH(OH)CH₂OH (p and q are integers). Further, Patent Document 3 discloses a lubricant, for use in a magnetic recording medium, which includes a perfluorooxyalkylene unit selected from (—CF₂O—) and (—CF₂CF₂O—), and a phosphazene compound.

On the other hand, in order to enhance the recording density of a magnetic recording/reproducing device, it is necessary to reduce the floating amount of a magnetic head to bring the magnetic head closer to a surface of a magnetic recording medium.

However, in the related art, there is such a problem that ionic contaminants may be easily present on the surface of the magnetic recording medium. Most of the ionic contaminants are adhered to the surface of the magnetic recording medium from the outside (peripheral environments or handling of the magnetic recording medium, for example) in a manufacturing process of the magnetic recording medium. Further, when the magnetic recording medium is used inside a hard disk drive, environmental contaminants may enter into the drive to adhere to the surface of the magnetic recording medium. For example, in a case where the magnetic recording medium or the hard disk drive is held under high temperature and high humidity conditions, water or the like containing environmental substances such as ions adheres to the surface of the magnetic recording medium. This water containing environmental substances such as ions passes through the lubricant layer, and condenses minute ionic components present below the lubricant layer, to thereby generate ionic contaminants.

In a case where such contaminants are present on the magnetic recording medium, even if the amount of contaminants is small, when the magnetic head is brought close to the surface of the magnetic recording medium, the magnetic head easily comes in contact with the contaminants, and thus the contaminants are adhered (transferred) to the magnetic head. If the contaminants are adhered (transferred) to the magnetic head, the recording/reproducing characteristics of the magnetic head are deteriorated, and the floating stability of the magnetic head is deteriorated. Further, the magnetic head may be damaged in some cases. Further, in the case of ionic contaminants, the ionic contaminants may cause a corrosive reaction of the recording layer in a minute defective portion (pinhole) of the protective film. Thus, when the magnetic recording medium is manufactured or is used inside the drive, it is necessary to remove such contaminants or prevent such contaminants from occurring.

In order to remove contaminants, for example, Patent Document 4 discloses a method of scrubbing a surface of a magnetic recording medium which is formed with a protective film with pure water, removing formic acid ions, oxalate ions, ammonium ions, or other ionic salts (SO₄²⁻, NO₃⁻, Na⁺) attached to the surface of the magnetic recording medium, and then coating a lubricant on a surface of the magnetic recording medium.

However, the lubricant layer is generally formed by adjusting solution including a lubricant by dissolving or diffusing a fluoroplastic based lubricant in a fluorine based solvent, and then by coating this solution on the protective layer. A spin coating method, a dipping method or the like is used for the coating process. For example, in the case of the dipping method, the magnetic recording medium is dipped into a solution including the lubricant which is contained in a lubricant dipping container, and then is lifted from the lubricant dipping container at a predetermined speed, to form the lubricant layer having a uniform thickness on the surface of the magnetic recording medium.

In a case where the floating amount of the magnetic head of the magnetic recording/reproducing device becomes small so as to enhance the recording density, it is necessary to reduce the thickness of the lubricant layer. However, if the thickness of the lubricant layer is reduced, the coverage of the lubricant layer on the surface of the magnetic recording medium is reduced. Thus, a part of the surface of the magnetic recording medium may be exposed in some cases, and the surface of the magnetic recording medium may be contaminated with contaminants through this exposed part.

According to the above-mentioned methods in the related art, as the recording density of the magnetic recording/reproducing device is increased, the floating amount of the magnetic head is decreased, and thus, trace amounts of contaminants become significant. However, it is difficult to completely remove the trace amounts of contaminants from the magnetic recording medium. Thus, the contaminants may be adhered (transferred) to the magnetic head, to thereby make the magnetic recording/reproducing characteristics of the magnetic recording/reproducing device unstable. In this regard, Patent Document 5 discloses a technique in which the coverage of a lubricant on a surface of a magnetic recording medium is adjusted using ion scattering, and the magnetic recording medium is used with the coverage improved in this way, to thereby enhance corrosion resistance.
[Patent Document 1] JP-A-62-66417
[Patent Document 2] JP-A-9-282642
[Patent Document 3] JP-A-2002-275484
[Patent Document 4] JP-A-2000-235708
[Patent Document 5] JP-A-2004-164704

### DISCLOSURE OF INVENTION

Accordingly, it is an object of the present invention to provide a method for inspection of a magnetic recording medium which is capable of reducing contaminants, which are adhered to a magnetic recording medium or enter inside the magnetic recording medium to corrode the magnetic recording medium, to the extreme limit, and of preventing the contaminants or corrosive substances from being adhered (transferred) to a magnetic head, and to provide a magnetic recording medium and a magnetic recording/reproducing device which have stable magnetic recording/reproducing characteristics.

As mentioned above, a lubricant layer having an average thickness of about 20 angstroms (2 nm) is formed on a surface of a magnetic recording medium. Here, since the lubricant is a highly polymerized compound having an average molecular weight of about 2,000 to about 5,000, it is considered that it is difficult for the lubricant layer to uniformly coat the entire surface of a carbon protective film with its thickness, and the lubricant layer is formed on the surface of the carbon protective film of the magnetic recording medium in an island shape or a net shape. That is, it is considered that environmental contaminants entering inside a hard disk drive easily pass through the lubricant layer and reach the surface of the carbon protective film disposed under the lubricant layer.

The present inventors researched a corrosion mechanism of a magnetic recording medium, and found that environmental contaminants are adhered to a “polarity site” which is present on a surface of a carbon protective film and the adhered contaminants enter inside the magnetic recording medium to corrode a magnetic layer or the like. Further, the inventors researched a method of preventing the progress of corrosion, and found that a functional group having high polarity is included in a compound structure of a lubricant and the functional group is bonded with the “polarity site” of the carbon film to thereby noticeably enhance corrosion resistance of the magnetic recording medium. Further, the inventors found a method of easily measuring the strength of a bonding force between the polarity functional group of the lubricant and the “polarity site” of the carbon film and a magnetic recording medium having high resistance, to thereby complete the present invention.

That is, the present invention relates to the following configurations.

(1) A method for inspection of a magnetic recording medium which includes at least a magnetic layer, a protective layer and a lubricant layer on a non-magnetic substrate, the method including: exposing the magnetic recording medium to an atmosphere containing siloxane; and inspecting resistance of the magnetic recording medium against environmental substances from the amount of the siloxane attached to a surface of the magnetic recording medium.
(2) The method according to (1), wherein the exposure to the atmosphere containing the siloxane is performed while rotating the magnetic recording medium.
(3) The method according to (1) or (2), wherein the siloxane is octamethylcyclotetrasiloxane.
(4) A magnetic recording medium including at least a magnetic layer, a protective layer and a lubricant layer on a non-magnetic substrate, wherein the lubricant layer includes a compound which has a functional group of high polarity in its structure, and the function group and a functional group on a surface of the protective layer are bonded with each other, and wherein after the magnetic recording medium is exposed for 8 hours to air containing octamethylcyclotetrasiloxane at atmospheric pressure while being rotated at 2,000 rpm or higher, the amount of siloxane attached to a surface of the magnetic recording medium is 1.5 times or less that before exposure.
(5) The magnetic recording medium according to (4), wherein the lubricant layer includes a single compound or two or more compounds selected from the following general formulas (1) to (5):

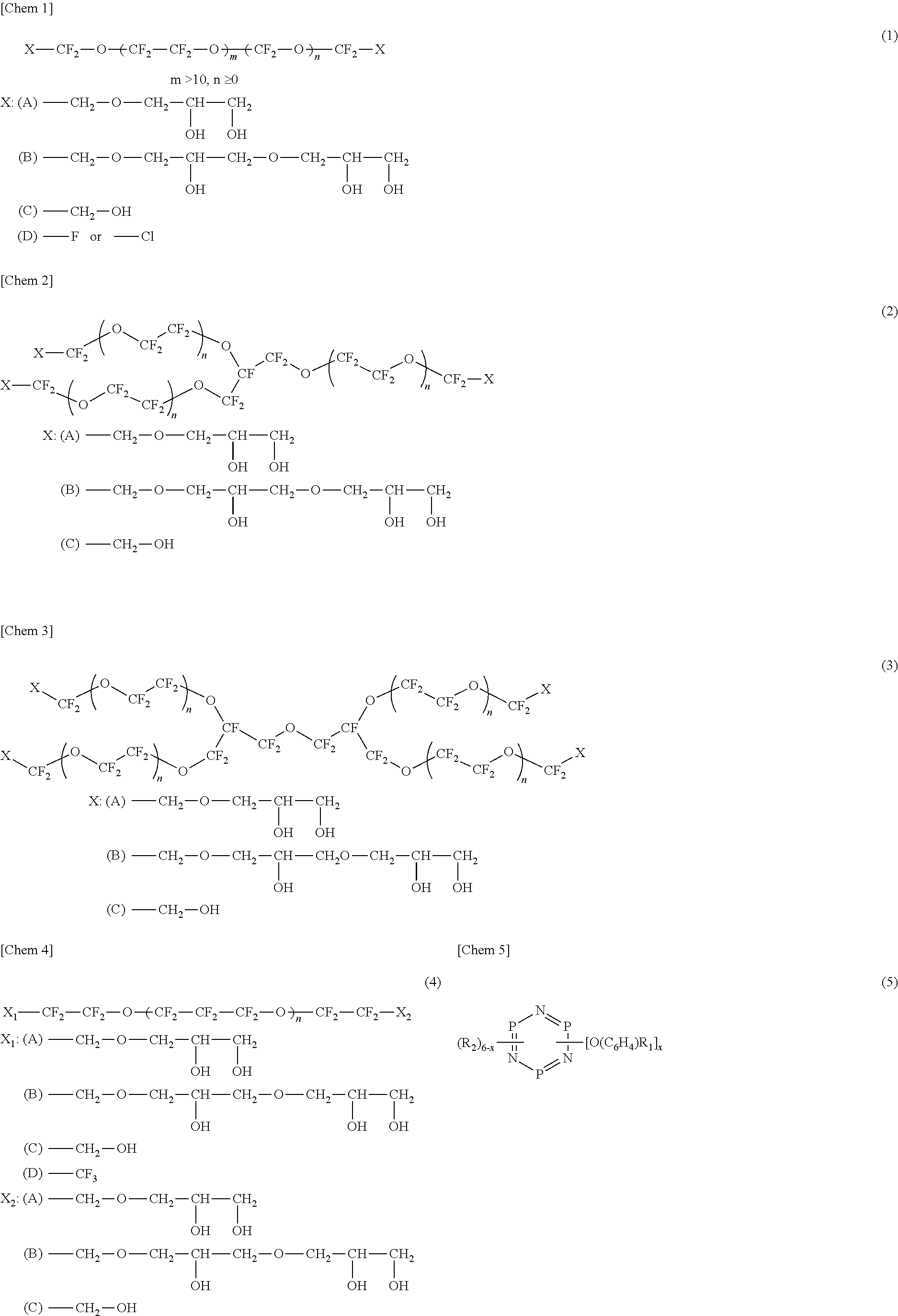

where in the general formulas (1) to (4), a terminal functional group structure expressed as at least one or more (A) or (B) should be contained in the structure, and in the general formula (5), x is an integer of 1 to 5, R₁ is any one of a hydrogen atom, an alkyl group having a carbon number of 1 to 4 or an alkyl halide group having a carbon number or 1 to 4, and R₂ has a terminal functional group which is a perfluoropolyether chain of —CH₂OH or —CH(OH)CH₂OH, in which the perfluoropolyether chain of R₂ includes at least one or more among (CF₂CF₂O), (CF₂O), and (CF₂CF₂CF₂O) as a repeating unit.

(6) The magnetic recording medium according to (4) or (5), wherein the protective layer includes a carbon film.
(7) A magnetic recording/reproducing device including: a magnetic recording medium according to any one of (4) to (6); a medium driving section which drives the magnetic recording medium in a recording direction; a magnetic head which performs recording and reproduction of information to the magnetic recording medium; a head driving section which moves the magnetic head with respect to the magnetic recording medium; and a recording/reproducing signal processing section which processes a recording/reproducing signal from the magnetic head.

The magnetic recording medium according to the invention has advantages in that adhesion of environmental contaminants is reduced and environmental resistance becomes high. Thus, it is possible to prevent the contaminants from being transferred to a magnetic head from a surface of the magnetic recording medium, and to stabilize the magnetic recording/reproducing characteristics.

Using the method for inspection of the magnetic recording medium according to the invention, it is possible to easily optimize the manufacturing conditions of the magnetic recording medium having high corrosion resistance.

In the magnetic recording/reproducing device according to the invention, contamination or damage of a magnetic head due to contaminants on a magnetic recording medium does not easily occur. Thus, it is possible to provide a magnetic recording/reproducing device which has excellent environmental resistance and a stable magnetic recording/reproducing characteristic.

### BRIEF DESCRIPTION OF THE DRAWINGS

FIG. 1 is a sectional view schematically illustrating an example of a magnetic recording medium according to the present invention.

FIG. 2 is a perspective view illustrating an example of a magnetic recording/reproducing device according to the present invention.

### DETAILED DESCRIPTION OF THE INVENTION

Hereinafter, a method for inspection of a magnetic recording medium, a magnetic recording medium and a magnetic recording/reproducing device according to the present invention will be described in detail with reference to the accompanying drawings. In the drawings described hereinafter, characteristic portions may be enlarged for ease of description, and the size scale or the like of respective components are not limited to the actual scale.

### <Magnetic Recording Medium>

Firstly, a magnetic recording medium used for the method for inspection of the magnetic recording medium according to an embodiment of the invention will be described.

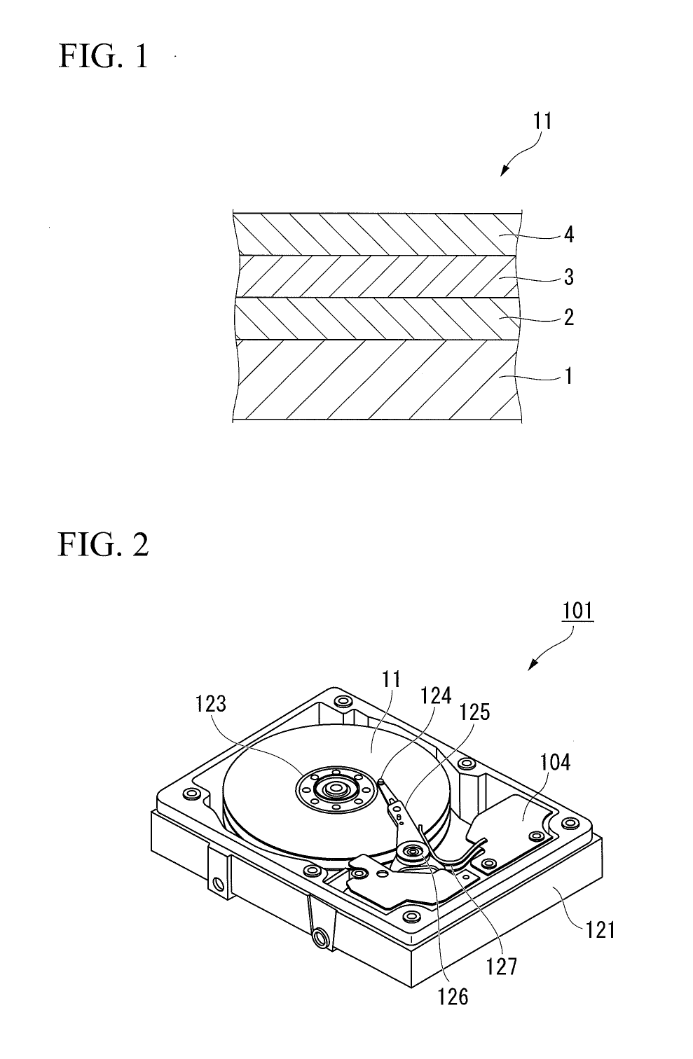

As shown in FIG. 1, a magnetic recording medium 11 according to the present embodiment is schematically configured by sequentially layering a magnetic layer 2, a protective layer 3 and a lubricant layer 4 on a non-magnetic substrate 1.

### (Non-Magnetic Substrate)

As the non-magnetic substrate 1, a substrate achieved by forming a film formed of NiP or NiP alloy on a substrate formed of metal or alloy material such as Al or Al alloy may be used. Further, as the non-magnetic substrate 1, a substrate formed of non-metallic material such as glass, ceramics, silicon, silicon carbide, carbon or resin may be used, or a substrate formed of a film of NiP or NiP alloy on the substrate formed of the non-metallic material may be also used.

### (Magnetic Layer)

The magnetic layer 2 is preferably formed of Co based alloy, and for example, a layer formed of Co—Cr—Ta based alloy, Co—Cr—Pt based alloy, Co—Cr—Pt—Ta based alloy, Co—Cr—Pt—B—Ta based alloy, or the like may be used.

Further, the magnetic layer 2 may be a magnetic layer of either longitudinal magnetic recording or of perpendicular magnetic recording (also referred to as a magnetic recording layer), and the magnetic layer of perpendicular magnetic recording is preferable in order to realize a higher recording density. As the magnetic layer 2 of longitudinal magnetic recording, a ferromagnetic CoCrPtTa magnetic layer may be used. In this case, it is preferable to form a non-magnetic CrMo base layer (not shown) between the magnetic layer 2 and the non-magnetic substrate 1. The base layer may be a single layer or multiple layers.

As the magnetic layer 2 of perpendicular magnetic recording, a magnetic layer formed of 60Co-15Cr-15Pt alloy or 70Co-5Cr-15Pt-10SiO₂ alloy may be used, and it is preferable to form a underlayer (not shown) formed of a soft magnetic FeCo alloy (FeCoB, FeCoSiB, FeCoZr, FeCoZrB, FeCoZrBCu or the like), FeTa alloy (FeTaN, FeTaC or the like), Co alloy (CoTaZr, CoZrNB, CoB or the like), or the like; an orientation control film (not shown) such as Pt, Pd, NiCr, NiFeCr or the like; and an intermediate layer (not shown) such as Ru, as necessary, are formed between the magnetic layer 2 and the non-magnetic substrate 1, for example.

The thickness of the magnetic layer 2 is preferably in a range of 3 nm or larger and 20 nm or smaller, and more preferably in a range of 5 nm or larger and 15 nm or smaller.

Further, the magnetic layer 2 may be formed by any known method such as deposition, ion beam sputtering, magnetron sputtering or the like, and is usually formed by a sputtering method.

### (Protective Layer)

As the protective layer 3, known materials, for example, carbon (typically, hard carbon or diamond-like carbon), an elementary substance of SiC, or material containing any of these materials as a main ingredient may be used, but since the attachment effect of siloxane to a “polarity site” noticeably appears, particularly when a carbon film is used as the protective layer 3, it is preferable to use a carbon film.

The thickness of the protective layer 3 is preferably in a range of 1 nm to 10 nm. Thus, in the case of high recording density state, it is possible to reduce a magnetic spacing and to enhance durability. Here, the magnetic spacing refers to a distance between a magnetic head (particularly, element section) and the magnetic layer 4. As the magnetic spacing is narrowed, it is possible to enhance the electromagnetic conversion characteristics.

As a method of forming the protective layer 3, a sputtering method which uses a typical carbon target material, a CVD (chemical vapor deposition) method which uses hydrocarbon materials such as ethylene or toluene, an IBD (ion beam deposition) method or the like may be used. Further, a plurality of layers may be formed by combining these methods. Further, in order to enhance the strength of the protective film or increase the affinity with a lubricant, nitrogen atoms may be added to a carbon film. As a method of adding the nitrogen atoms, a method of mixing nitrogen gas with carrier gas or material gas to be used for the sputtering method or the CVD method, or a method of exposure to a nitrogen gas plasma atmosphere after formation of the carbon film, may be used.

### (Lubricant Layer)

The lubricant layer 4 preferably uses a single compound or two or more compounds selected from the following general formulas (1) to (5). Here, the general formulas (1), (2), (3) and (4) are perfluoropolyether compounds. Further, the general formula (5) is a phosphazene compound having a perfluorooxyalkylene unit.

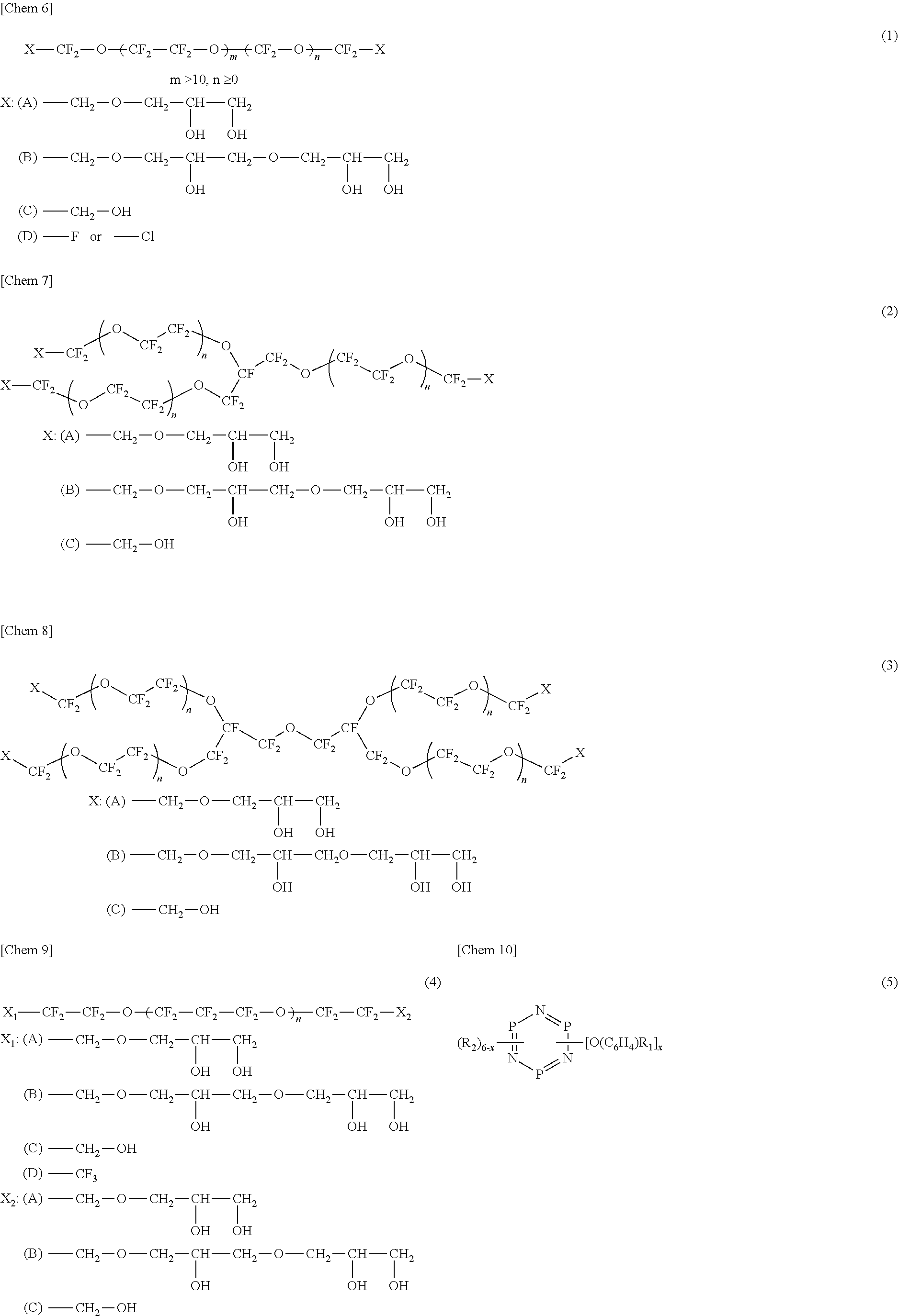

Here, in the general formulas (1) to (4), a terminal functional group structure expressed as at least one or more (A) or (B) should be contained in the structure.

Further, in the general formula (5), x is an integer of 1 to 5; R₁ is one of a hydrogen atom, an alkyl group having a carbon number of 1 to 4 or an alkyl halide group having a carbon number or 1 to 4; and R₂ has a terminal functional group which is a perfluoropolyether chain of —CH₂OH or —CH(OH)CH₂OH. Here, the perfluoropolyether chain of R₂ includes at least one among (CF₂CF₂O), (CF₂O), and (CF₂CF₂CF₂O) as a repeating unit.

As the compounds shown in the general formulas (1) to (4), for example, Fomblin Z-DOL (product name, made by Solvay Solexis), Fomblin Z-TETRAOL (product name, made by Solvay Solexis) or reaction products obtained by combining these related substances as starting materials and purifying them may be used.

Further, as the compound of the general formula (5), X-1p (product name, made by The Dow Chemical Company), MORESCO PHOSPHAROL A20H-2000 (product name, made by Matsumura Oil Research Corp. (MORESCO)), A20H-DD (product name, made by Matsumura Oil Research Corp. (MORESCO)), or reaction products obtained by combining these related substances as starting materials and purifying them may be used.

When the lubricant layer 4 exposes the magnetic recording medium 11 in which the lubricant layer 4 (to be described later) is formed in an atmosphere containing the siloxane compound, it is important that the amount of attachment of the siloxane to the surface of the magnetic recording medium 11 is low. That is, since the polarity functional group of the lubricant included in the lubricant layer 4 is bonded with a functional group on the surface of the protective film, the magnetic recording medium 11 has good resistance against environmental substances of the magnetic recording medium 11. In order to achieve such a lubricant, it is necessary to contain a functional group having high polarity, for example, a hydroxyl group or a glycidyl group in a compound structure, and to bond the functional group with high polarity with the “polarity site” of the protective layer 3.

According to the method for inspection of the magnetic recording medium according to the present embodiment which will be described later, it is easy to search the lubricant functional group having a strong bonding force with the functional group on the surface of the protective film. Accordingly, it is possible to synthesize the lubricant which contains a large amount of the functional group having a strong bonding force with the functional group on the surface of the protective film.

### (Thickness of Lubricant Layer)

The average thickness of the lubricant layer 4 is preferably in a range 0.5 nm to 3 nm, and more preferably in a range of 0.5 nm to 2 nm. By setting the average thickness of the lubricant layer 4 in the above-mentioned range, it is possible to enhance a protection effect of the magnetic recording medium 11 and to prevent the magnetic head from being contaminated due to transfer of the lubricant to the magnetic head. Further, it is possible to sufficiently reduce the floating amount of the magnetic head, to thereby enhance the recording density of the magnetic recording medium 11.

### (Method of Forming Lubricant Layer)

After a lubricant layer forming solution is prepared, the lubricant layer 4 is formed by coating the lubricant layer forming solution on the magnetic recording medium 11.

Generally, a lubricant elementary substance is an oily liquid with thick viscosity. Thus, the lubricant is diluted by a solvent to obtain a lubricant layer forming solution (coating solution) having a density suitable for a coating method. As the solvent used herein, for example, a fluorine series solvent such as Vertrel XF (product name, made by DuPont-Mitsui Fluorochemicals Co., Ltd.) may be used.

Next, the lubricant layer forming solution is coated on the protective layer 3 using a spin coating method, a dipping method or the like, to form the lubricant layer 4. For example, in the dipping method, the non-magnetic substrate 1 which is formed with the respective layers up to the protective layer 3 is dipped in the lubricant layer forming solution contained in a lubricant dipping container of a dip coating device, and then the non-magnetic substrate 1 is lifted from the lubricant dipping container at a predetermined speed, to form the lubricant layer 4 having a uniform thickness on the surface of the protective layer 3 of the non-magnetic substrate 1.

### <Method of Inspecting Magnetic Recording Medium>

Next, a method for inspection of a magnetic recording medium according to an embodiment of the invention will be described.

The inspection method of the magnetic recording medium 11 according to the present embodiment includes exposing the magnetic recording medium 11 including at least the magnetic layer 2, the protective layer 3, and the lubricant layer 4 on the non-magnetic substrate 1 to the atmosphere containing the siloxane; and inspecting resistance against the environmental substances of the magnetic recording medium 11 from the amount of the siloxane attached to the surface of the magnetic recording medium 11. As described above, the lubricant layer 4 does not coat the entire surface of the protective layer 3 formed of carbon, and is formed in an island shape or a net shape on the surface of the protective film 3 of the magnetic recording medium 11. Therefore, the environmental contaminants entering inside a hard disk drive easily go through the lubricant layer 4, and reach the surface of the protective film 3 under the lubricant layer 4.

Here, the protective film 3 formed of the carbon film is known as a substance which is from the outset chemically stable and has high resistance. However, according to research of the present inventors, the “polarity site” is present on the surface of the protective layer 3 formed of the carbon film used for the magnetic recording medium 11, and the environmental contaminants are adhered to the “polarity site”. The adhered environmental contaminants become massed together in the site to contaminate the magnetic head, and reach the magnetic layer 2 through the protective film 3, to thereby corrode the magnetic layer 2 to reduce the magnetic characteristic. Further, the corrosive materials of the magnetic layer 2 expand on the surface of the protective film 3, to thereby contaminate the magnetic head.

In this specification, the “polarity site” refers to a functional group which includes oxygen atoms such as a hydroxyl group (—OH), carboxylic acid group (—COOH) or carbonyl group (—C═O), a functional group which includes nitrogen atoms such as a cyano group (—CN) or amino group (—NH₃), or a portion (dangling-bond) where carbon atoms in the carbon film are in a radical state and do not form covalent bonding, which is present on the surface of the carbon film.

The present inventors found that when the compound structure of the lubricant contains the functional group having high polarity, and the functional group is bonded with the “polarity site” of the carbon film, as a result, the resistance against the contaminants of the magnetic recording medium is enhanced. Further, the present inventors contrived a method of using the amount of the siloxane attached to the surface of the magnetic recording medium in order to inspect the bonding force. That is, according to such research of the present inventors, the siloxane is attached to the “polarity site” of the carbon film, but in a case where the polarity functional group of the lubricant is strongly bonded with the “polarity site”, it is difficult to attach the siloxane thereto. Accordingly, it is possible to quantify the bonding force of the polarity functional group of the lubricant to the “polarity site” of the carbon film, and thus to quantify the resistance against the environmental contaminants of the magnetic recording medium, by exposing the magnetic recording medium to the siloxane atmosphere, and then investigating the amount of the siloxane attached to the surface of the magnetic recording medium.

The environmental contaminants in the present embodiment are ion impurities, for example. As metal ions included in the ion impurities, for example, there are sodium ions, potassium ions, or the like. Further, as inorganic ions, for example, there are silicon ions, chlorine ions, HCO₃ ions, HSO₄ ions, sulfate ions, ammonia ions, oxalate ions, formic acid ions, or the like.

In the present embodiment, the siloxane generally refers to a compound which has a structure including silicon and oxygen and has a Si—O—Si bonding (siloxane bonding). Further, the siloxane can be expressed as R₃SiO—(R₂SiO)n-SiR₃ (R represents an alkyl group) as a general formula, for example. According to the research of the inventors, it is possible to bond the siloxane with the “polarity site” of the carbon film, but in a case where a different substance is bonded with the “polarity site” of the carbon film, it is difficult to bond the siloxane with this bonding portion.

In the present embodiment, a method of inspecting the amount of the siloxane attached to the surface of the magnetic recording medium may include a known surface analysis method. Specifically, for example, the siloxane attached to the surface of the magnetic recording medium is detached, the detached siloxane is measured by a secondary ion mass spectrometer, and then the measurement result is compared with the measurement result on the magnetic recording medium before exposure. The ratio of the attachment amount after exposure measured by the secondary ion mass spectrometer to the attachment amount before exposure (attachment ratio=attachment amount after exposure/attachment amount before exposure) is used as an index. In the present embodiment, the siloxane attachment ratio is preferably 1.5 or less, more preferably 1.2 or less, and most preferably 1.1 or less. If the siloxane attachment ratio exceeds 1.5, the floating of the head becomes unstable and reading and writing of magnetic signals becomes impossible in practical use, which is not desirable. Thus, it is possible to quantify the resistance of the magnetic recording medium against the environmental contaminants to approach the resistance in a more practical usage state.

In the present embodiment, when being exposed to the atmosphere containing the siloxane, it is preferable that the magnetic recording medium be rotated to match a practical magnetic recording medium usage state, that is, a state where the magnetic recording medium is built in the hard disk drive or the like for usage. Specifically, the exposure to the atmosphere containing the siloxane, is performed, for example, under the condition that the magnetic recording medium is rotated at a rotational speed of 2,000 rpm or more using the magnetic recording device, and is exposed for 8 hours in air including 0.5 volume % of the siloxane at atmospheric pressure.

The rotational speed of the magnetic recording medium is preferably 2,000 rpm or more, more preferably in a range of 3,600 to 15,000 rpm, and most preferably in a range of 4,200 to 15,000 rpm. If the rotational speed is smaller than 2,000 rpm, the attachment amount of the siloxane becomes unstable and reproducibility becomes poor, which is not desirable. On the other hand, if the rotational speed is in a range of 4,200 to 15,000 rpm, the attachment amount of the siloxane becomes stable, which is desirable.

In the present embodiment, it is preferable to use octamethylcyclotetrasiloxane as the siloxane. In a case where octamethylcyclotetrasiloxane is used as the siloxane, as described above, it is possible to bond the siloxane with the “polarity site” of the carbon film which is the protective film 3. Further, in a case where a different substance is bonded with the “polarity site” of the carbon film, it is possible to reliably reproduce the effect that the siloxane is not bonded in the bonding portion.

The percentage of the siloxane in air is preferably 0.1 to 5 volume %, more preferably in a range of 0.2 to 2 volume %, and most preferably in a range of 0.5 to 1 volume %. If the percentage of the siloxane is smaller than 0.1 volume %, the attachment amount of the siloxane is not saturated and the reproducibility becomes poor, which is not desirable. Further, if the percentage of the siloxane exceeds 5 volume %, an excessive amount may be accumulated on the surface thereof, which is not desirable. On the other hand, if the percentage of the siloxane is in a range of 0.2 to 2 volume %, the attachment amount of the siloxane becomes stable, which is desirable.

The exposure time of the air including the siloxane to the magnetic recording medium is preferably 3 hours or longer, more preferably 6 hours or longer, and most preferably 8 hours or longer. If the exposure time is shorter than 3 hours, the attachment amount of the siloxane is not saturated and the reproducibility becomes poor, which is not desirable. On the other hand, if the exposure time is 8 hours or longer, the attachment amount of the siloxane is stable, which is desirable.

### <Magnetic Recording/Reproducing Device>

Next, an example of a magnetic recording/reproducing device according to an embodiment of the invention will be described. FIG. 2 is a perspective view illustrating an example of a magnetic recording/reproducing device 101 according to the present embodiment. The magnetic recording/reproducing device 101 according to the present embodiment includes the magnetic recording medium 11 according to the present embodiment; a medium driving section 123 which drives the magnetic recording medium 11 in a recording direction; a magnetic head 124 which includes a recording section and a reproducing section; a head driving section 126 which relatively moves the magnetic head 124 to the magnetic recording medium 11; and a recording/reproducing signal processing section 128 which includes recording/reproducing signal processing means for performing signal input to the magnetic head 124 and output signal reproduction from the magnetic head 124. It is possible to configure the magnetic recording/reproducing device 101 with high recording density by combining these sections.

By forming an element section (reproducing section) of the magnetic head 124 of a GMR head or a TMR head, it is possible to obtain a sufficient signal intensity at high recording density, and to realize the magnetic recording/reproducing device 101 having high recording density. Further, if the floating amount of the magnetic head 124 is 0.005 μm (5 nm) to 0.020 μm (20 nm) which is lower than that used in the related art, it is possible to enhance the output to obtain high SNR, and to achieve the magnetic recording/reproducing device 101 with large capacity and high reliability.

Since the magnetic recording/reproducing device 101 according to the present embodiment includes the magnetic recording medium 11 according to the present embodiment and the magnetic head 124, it is possible to sufficiently reduce the floating amount of the magnetic head 124, and to enhance the recording density of the magnetic recording medium 11. Further, it is possible to noticeably reduce a friction force of the magnetic head 124 which slides on the magnetic recording medium 11, and even under a high temperature condition, and to prevent contamination or damage of the magnetic head 124 due to contaminants on the magnetic recording medium 11, and thus, it is possible to achieve the magnetic recording/reproducing device 101 which is excellent in environmental resistance and is stable in magnetic recording/reproducing characteristics.

### EXAMPLES

Hereinafter, examples of the present invention will be described in detail. However, the present invention is not limited to these examples.

### Examples 1 to 6, Comparative Examples 1 to 4

As the non-magnetic substrate, a crystalline glass substrate (made by Ohara Corporation) having an outer diameter of 65 mm, an inner diameter of 20 mm, and a thickness of 0.635 mm was prepared. Then, texturing was performed to this non-magnetic substrate, so as to perform sufficient cleansing and drying. Thereafter, the non-magnetic substrate through the texturing process was set in a chamber of a DC magnetron sputtering device (made by Canon Anelva Corporation (Japan), C3040), and then the chamber was discharged until vacuum pressure in the chamber reached 2×10⁻⁷ Torr (2.7×10⁻⁵ Pa).

Using the DC sputtering method, an FeCoB film which is a soft magnetic layer, a Ru layer which is an intermediate layer, and a 25Fe-30Co-45Pt layer which is a magnetic layer were sequentially formed on the non-magnetic substrate. The thicknesses of the respectively formed layers were 60 nm in the soft magnetic layer, 10 nm in the intermediate layer, and 15 nm in the magnetic layer.

Next, a protective film (carbon film) having a thickness of 3 nm was layered using the CVD method, and then the non-magnetic substrate which is formed with the respective layers from the chamber was extracted. In this way, the substrate before formation of the lubricant layer was prepared.

Then, the lubricant layer was formed on the protective layer of the substrate before formation of the lubricant layer using the dipping method.

Each lubricant layer was adjusted to have a thickness of 0.18 nm in consideration of Table 1. The types of the lubricant in Table 1 were as follows.

A-1: Lubricant in which X has an (A) structure of 76%, a (B) structure of 15%, a (C) structure 8%, and a (D) structure of 1%, in the general formula (1).

B-1: Lubricant in which X has an (A) structure of 70%, a (B) structure of 2% and a (C) structure of 28%, in the general formula (2).

C-1: Lubricant in which X has an (A) structure of 50%, a (B) structure of 1% and a (C) structure of 49%, in the general formula (3).

D-1: Lubricant in which X has an (A) structure of 80%, a (B) structure of 10%, a (C) structure of 5%, and a (D) structure of 5%, in the general formula (4).

E-1: Lubricant in which a lubricant of 20 weight %, in which R₁ is CF₃ and R₂ is —(CF₂CF₂O)ₘ—(CF₂O)ₙ—CH₂OH in the general formula (5) is mixed with a lubricant of 80 weight %, in which X has only the (C) structure in the general formula (1).

F-1: Lubricant in which a lubricant of 80 weight %, in which X has an (A) structure of 76%, a (B) structure of 15%, a (C) structure of 8%, and a (D) structure of 1% in the general formula (1) is mixed with a lubricant of 20 weight %, in which R₁ is CF₃ and R₂ is —(CF₂CF₂O)ₘ—(CF₂O)ₙ—CH₂OH in the general formula (5).

A-2: Lubricant in which X has only the (C) structure in the general formula (1).

B-2: Lubricant in which X has only the (C) structure in the general formula (2).

C-2: Lubricant in which X has only the (C) structure in the general formula (3).

D-2: Lubricant in which X has only the (C) structure in the general formula (4).

As a solvent for dissolving the lubricant layer forming solution, Vertrel XF (product name, made by DuPont-Mitsui Fluorochemicals Co., Ltd.) was used. Further, the concentration of the lubricant (compound A and compound B) in the lubricant layer forming solution was all 0.3 mass %. The dipping container of the dip coating device was filled with the lubricant layer forming solution, and then the substrate before formation of the lubricant layer was dipped therein. Thereafter, by lifting the substrate before formation of the lubricant layer from the dipping container at a predetermined lifting speed, the lubricant layer having a uniform thickness was formed on the substrate before formation of the lubricant layer, to thereby prepare the magnetic recording medium according to this embodiment. The average thickness of the lubricant layer was 1.95 nm.

### (Evaluation of Siloxane Attachment Amount)

The magnetic recording medium manufactured in one of the Examples 1 to 6 and Comparative Examples 1 to 4 was fixed to a spindle motor in a marketed magnetic recording device (2.5-inch hard disk drive, for example, MK1646GSX made by Toshiba Corporation, number of rotations of 5400 rpm). Octamethylcyclotetrasiloxane of 50 μL was dropped to a space in the device by a microsyringe, a cover of an upper part of the device was closed, and then the device was operated. By operating the device at room temperature for 8 hours, the exposure operation to siloxane was performed. Thereafter, the amount of the siloxane attached to the surface of the magnetic recording medium was measured by the second ion mass spectrometer (SIMS: TTS-2000 made by Oryx Corporation). Since a certain amount of the siloxane was attached to the surface of the magnetic recording medium even before the exposure process, the attachment amount was measured by the SIMS in advance before being assembled in the magnetic recording device, and the ratio between the attachment amount measured after the exposure process and the attachment amount measured before the exposure process (attachment ratio=the attachment amount measured after the exposure process/the attachment amount measured before the exposure process) was calculated to measure the attachment ratio of the siloxane.

TABLE 1

| | Lubricant | Si count (X) before | Si count (Y) after | Ratio |
|---|---|---|---|---|
| | type | exposure | exposure | (Y/X) |
| Example 1 | A-1 | 2.45 × 10⁵ | 2.49 × 10⁵ | 1.02 |
| Example 2 | B-1 | 2.41 × 10⁵ | 2.83 × 10⁵ | 1.17 |
| Example 3 | C-1 | 2.42 × 10⁵ | 2.72 × 10⁵ | 1.12 |
| Example 4 | D-1 | 2.45 × 10⁵ | 3.09 × 10⁵ | 1.26 |
| Example 5 | E-1 | 2.44 × 10⁵ | 2.58 × 10⁵ | 1.06 |
| Example 6 | F-1 | 2.43 × 10⁵ | 2.46 × 10⁵ | 1.02 |
| Comparative | A-2 | 2.44 × 10⁵ | 4.71 × 10⁵ | 1.93 |
| Example 1 | | | | |
| Comparative | B-2 | 2.42 × 10⁵ | 4.94 × 10⁵ | 2.04 |
| Example 2 | | | | |
| Comparative | C-2 | 2.46 × 10⁵ | 4.60 × 10⁵ | 1.87 |
| Example 3 | | | | |
| Comparative | D-2 | 2.41 × 10⁵ | 4.73 × 10⁵ | 1.96 |
| Example 4 | | | | |

### (Measurement Result of Siloxane Attachment Amount)

As shown in Table 1, the attachment amount ratios of silicon before and after the exposure process (ratio: Y/X) in the Comparative Examples 1 to 4 were larger than 1.5. On the other hand, the attachment amount ratios of silicon before and after the exposure process were all 1.5 or less in the Examples 1 to 6.

Accordingly, it could be understood from the Examples 1 to 6 according to the present invention that it is possible to enhance the coverage of the lubricant for the carbon protective film and to remove the polarity site on the surface of the carbon protective film by the functional group of the lubricant.

### REFERENCE SIGNS LIST

1 Non-magnetic substrate
2 Magnetic layer
3 Protective layer
4 Lubricant layer
11 Magnetic recording medium
101 Magnetic recording/reproducing device
123 Medium driving section
124 Magnetic head
126 Head driving section
128 Recording/reproducing signal processing section

1. A method for inspection of a magnetic recording medium which comprises at least a magnetic layer, a protective layer and a lubricant layer on a non-magnetic substrate, the method comprising:
exposing the magnetic recording medium to an atmosphere containing siloxane; and
inspecting resistance of the magnetic recording medium against environmental substances from the amount of the siloxane attached to a surface of the magnetic recording medium.

2. The method according to claim 1,
wherein the exposure to the atmosphere containing the siloxane is performed while rotating the magnetic recording medium.

3. The method according to claim 1,
wherein the siloxane is octamethylcyclotetrasiloxane.

4. A magnetic recording medium comprising at least a magnetic layer, a protective layer and a lubricant layer on a non-magnetic substrate,
wherein the lubricant layer comprises a compound which has a functional group of high polarity in its structure, and the function group and a functional group on a surface of the protective layer are bonded with each other, and
wherein after the magnetic recording medium is exposed for 8 hours to air containing octamethylcyclotetrasiloxane at atmospheric pressure while being rotated at 2,000 rpm or higher, the amount of siloxane attached to a surface of the magnetic recording medium is 1.5 times or less than that before exposure.

5. The magnetic recording medium according to claim 4,
wherein the lubricant layer comprises a single compound or two or more compounds selected from the following general formulas (1) to (5): 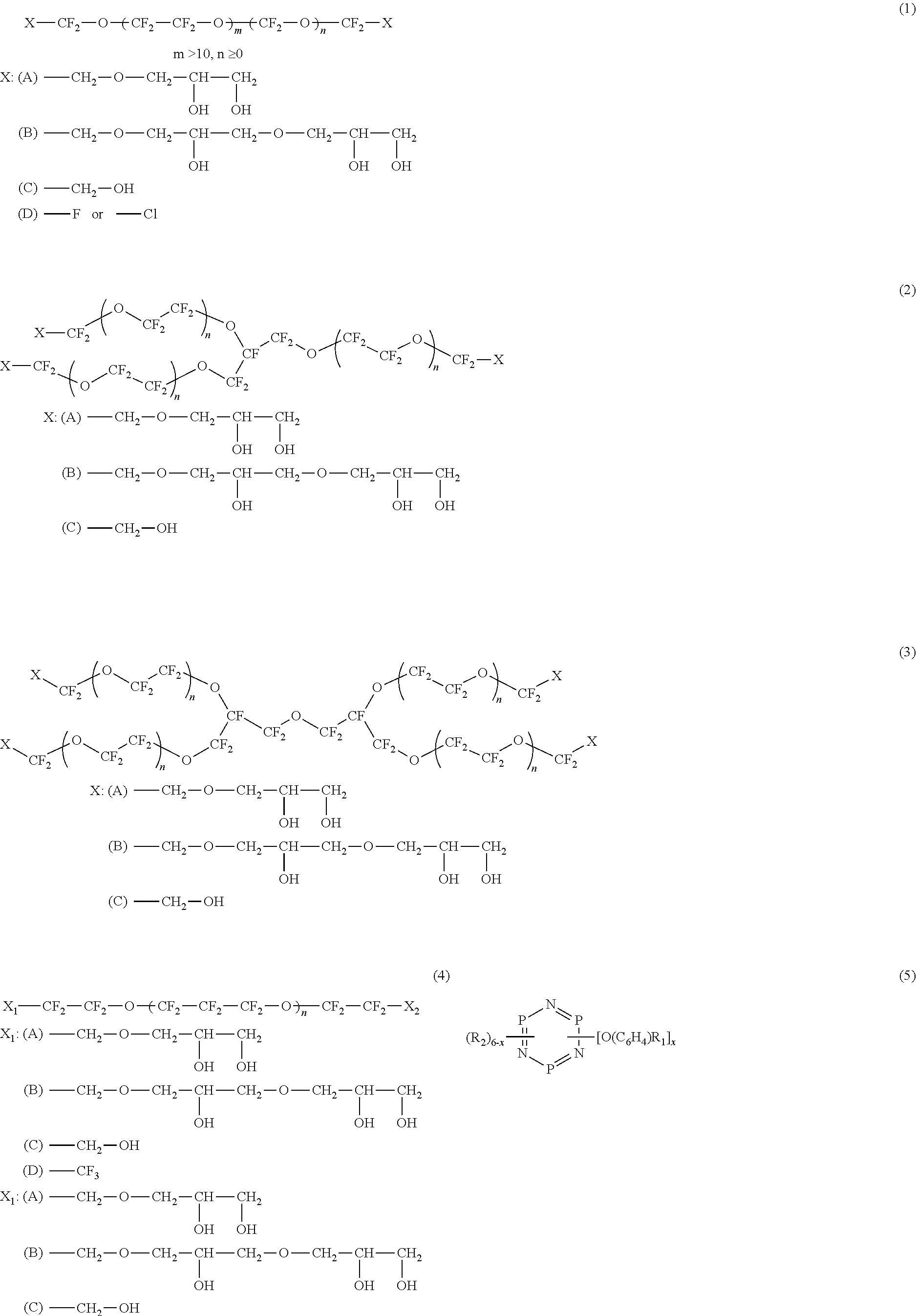
where in the general formulas (1) to (4), a terminal functional group structure expressed as at least one or more (A) or (B) should be contained in the structure, and in the general formula (5), x is an integer of 1 to 5, R₁ is any one of a hydrogen atom, an alkyl group having a carbon number of 1 to 4 or an alkyl halide group having a carbon number or 1 to 4, and R₂ has a terminal functional group which is a perfluoropolyether chain of —CH₂OH or —CH(OH)CH₂OH, in which the perfluoropolyether chain of R₂ comprises at least one among (CF₂CF₂O), (CF₂O), and (CF₂CF₂CF₂O) as a repeating unit.

6. The magnetic recording medium according to claim 4,
wherein the protective layer comprises a carbon film.

7. A magnetic recording/reproducing device comprising:
a magnetic recording medium according to claim 4;
a medium driving section which drives the magnetic recording medium in a recording direction;
a magnetic head which performs recording and reproduction of information to the magnetic recording medium;
a head driving section which moves the magnetic head with respect to the magnetic recording medium; and
a recording/reproducing signal processing section which processes a recording/reproducing signal from the magnetic head.

8. A magnetic recording/reproducing device comprising:
a magnetic recording medium according to claim 5;
a medium driving section which drives the magnetic recording medium in a recording direction;
a magnetic head which performs recording and reproduction of information to the magnetic recording medium;
a head driving section which moves the magnetic head with respect to the magnetic recording medium; and
a recording/reproducing signal processing section which processes a recording/reproducing signal from the magnetic head.

9. A magnetic recording/reproducing device comprising:
a magnetic recording medium according to claim 6;
a medium driving section which drives the magnetic recording medium in a recording direction;
a magnetic head which performs recording and reproduction of information to the magnetic recording medium;
a head driving section which moves the magnetic head with respect to the magnetic recording medium; and
a recording/reproducing signal processing section which processes a recording/reproducing signal from the magnetic head.

10. The method according to claim 2,
wherein the siloxane is octamethylcyclotetrasiloxane.

11. The magnetic recording medium according to claim 5,
wherein the protective layer comprises a carbon film.
